(19) United States
(12) Patent Application Publication
(10) Pub. No.: US 2013/0260132 A1
(43) Pub. Date: Oct. 3, 2013

(54) HYBRID THERMAL BARRIER COATING

(71) Applicants: Brian T. Hazel, Avon, CT (US); David A. Litton, West Hartford, CT (US); Michael J. Maloney, Marlborough, CT (US)

(72) Inventors: Brian T. Hazel, Avon, CT (US); David A. Litton, West Hartford, CT (US); Michael J. Maloney, Marlborough, CT (US)

(73) Assignee: UNITED TECHNOLOGIES CORPORATION, Hartford, CT (US)

(21) Appl. No.: 13/437,261

(22) Filed: Apr. 2, 2012

(51) Int. Cl. B32B 18/00; C23C 4/10; B32B 3/26; B05D 1/36; B32B 5/00; B32B 15/04

(52) U.S. Cl. 428/304.4; 428/697; 428/332; 428/457; 427/454

(57) ABSTRACT

A tubine engine component has a substrate, a thermal barrier layer deposited onto the substrate, and a sealing layer of ceramic material deposited on an outer surface of the thermal barrier layer for limiting molten sand penetration. The thermal barrier layer and sealing layer are formed by suspension plasma spraying. A preferred sealing layer is gadolinium zirconate.

### BACKGROUND

Turbine engine airfoils used in desert environments may degrade due to sand related distress of thermal barrier coatings. The mechanism for such distress is believed to be related to the penetration of molten sand deposits into yttria stabilized zirconia thermal barrier coatings on the hot turbine components during engine operation. During flight, turbine engines ingest siliceous particles such as dust, sand, volcanic ash, and other materials that, at higher operating temperatures, form calcium-magnesium-alumino-silicate (CMAS) melts that penetrate the thermal barrier coatings. Following operation, the melt solidifies. In subsequent operations, the infiltrated solid melt generates internal stresses due to thermal expansion mismatch that compromises the mechanical integrity of the thermal barrier coating. Spallation and resulting accelerated oxidation of exposed metallic substrate result. It has been observed that when gadolinia stabilized zirconia coatings react with fluid sand deposits, a reaction product forms that inhibits fluid sand penetration into the coating. The reaction product has been identified as a silicate oxyapatite/garnet phase containing primarily gadolinia, calcia, zirconia, and silica.

There remains a need, however, for a coating system which effectively deals with sand related distress.

### SUMMARY

A turbine engine component is provided which uses a suspension plasma sprayed dense outer layer on top of a strain tolerant thermal barrier coating to block the penetration of molten sands into the thermal barrier coating.

In an embodiment a method is provided for forming a coating on a turbine engine component comprising the steps of suspension plasma spraying a strain tolerant thermal barrier coating on a surface of the turbine engine component, and suspension plasma spraying a denser sealing layer onto the thermal barrier coating.

### BRIEF DESCRIPTION OF THE DRAWINGS

FIG. 1 is a schematic representation of a thermal barrier coating system.

FIG. 2 is a schematic representation of another embodiment of a thermal barrier coating system.

### DETAILED DESCRIPTION

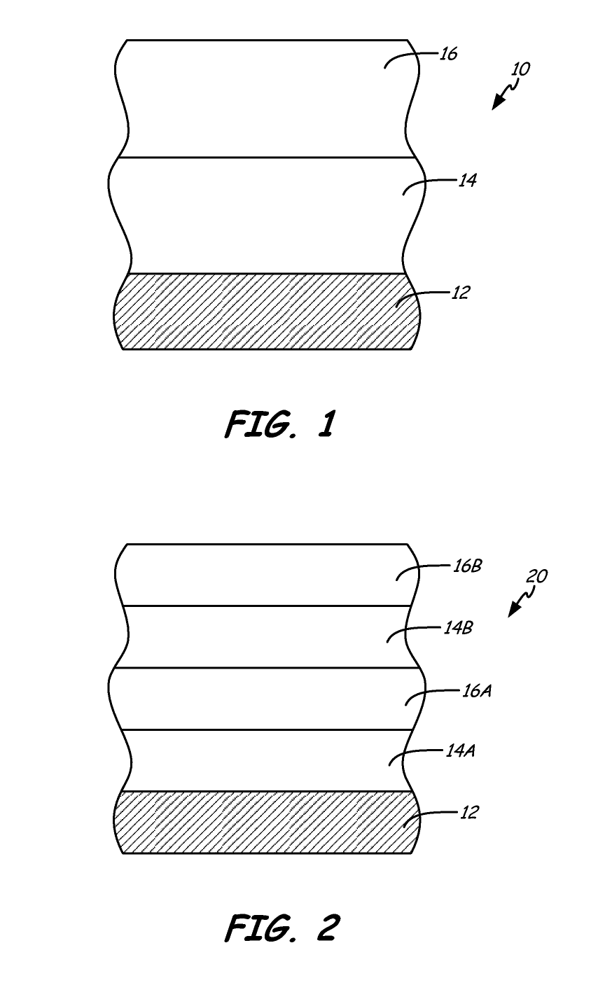

FIG. 1 shows turbine engine component 10 such as a blade, a vane, a combustor, a panel, or a seal having substrate 12, such as an airfoil portion or a platform portion of a blade or vane or a portion of a combustor panel or a portion of a seal, and thermal barrier coating 14 on at least one surface of substrate 12. Substrate 12 may be formed from any suitable material known in the art such as a nickel based superalloy, a cobalt based superalloy, a molybdenum based alloy, or a niobium based alloy. Alternatively, substrate 12 may be a ceramic based substrate or a ceramic matrix composite substrate.

Thermal barrier coating 14 may comprise one or more layers of a ceramic material such as a yttria stabilized zirconia material or a gadolinia stabilized zirconia material. The yttria stabilized zirconia material may contain from 1.0 to 25 wt. % yttria and the balance zirconia. The gadolinia stabilized zirconia material may contain from 5.0 to 99.9 wt. % gadolinia, more preferably 30 to 70 wt. % gadolinia and the balance zirconia. Thermal barrier coating 14 may have a thickness from about 25 microns to about 1300 microns.

It is preferred that thermal barrier coating 14 have a strain tolerant microstructure comprising vertical gaps or microcracks and a porosity of from 10 to 30%.

If desired, a bond coat may be deposited on the substrate prior to the application of thermal barrier coating 14. The bond coat may be either a MCrAlY coating where M is nickel and/or cobalt, an aluminide coating, a platinum aluminide coating, a ceramic based bond coat, or a silica based bond coat. The bond coat may be applied using any suitable technique known in the art.

After thermal barrier coating 14 has been applied to substrate 12, protective sealing layer 16 is applied to thermal barrier coating 14. Protective sealing layer 16 may be rare earth stabilized zirconia, rare earth stabilized hafnia, and mixtures thereof. In an embodiment, protective sealing layer 16 may be yttria stabilized zirconia, gadolinia stabilized zirconia, yttria stabilized hafnia, gadolinia stabilized hafnia, and mixtures thereof. Preferably, protective sealing layer 16 may be yttria stabilized zirconia containing from about 17 wt. % yttria to about 65 wt. % yttria, gadolinia stabilized zirconia containing from about 25 wt. % gadolinia to about 70 wt. % gadolinia, yttria stabilized hafnia containing from about 11 wt. % yttria to about 52 wt. % yttria, gadolinia stabilized hafnia containing from about 16 wt. % hafnia to about 53 wt. % hafnia, and mixtures thereof. Most preferably, protective sealing layer 16 is gadolinium zirconate, Gd₂Zr₂O₇. Protective sealing layer 16 is denser than thermal barrier layer 14 and has a porosity less than 20%, more preferably less than 10% and a minimum amount of vertical gaps or microcracks.

It is an object of the present invention to deposit thermal barrier coating 14 and protective sealing layer 16 by suspension plasma spraying (SPS) using the same deposition equipment for both coatings. Suspension plasma spraying is superior to conventional plasma spraying in that smaller particles can be used in the feedstock that enable the formation of fine columns separated by vertical gaps or microcracks providing strain tolerance to the coating during thermal cycling. In conventional plasma spraying, solid particles in the size range of about 10 microns to about 100 microns are used to produce laminar microstructures containing lamellae or splats with diameters of about 10 to about a few hundred microns and thicknesses of from about 1 micron to about 5 microns. Feedstock particle sizes in suspension plasma spraying are nominally less than about 1 micron. Particles of this size cannot be deposited by conventional plasma spray processes because current dry particle feeders are insufficient to entrain the fine particles into the fast moving gas stream. A liquid carrier is required to hold the fine particles in suspension and provide the mass sufficient to inject and entrain the particles into the fast moving gas stream.

In one form of SPS, the feedstock is dispersed as a suspension in a fluid, typically ethanol, and injected wet into the gas stream. Splat sizes in SPS with micron or submicron powder feedstock may be about ½ micron to about 3 microns in diameter and thicknesses less than a micron. The resulting microstructures in SPS deposited layers have features that are much smaller than conventional plasma sprayed microstructures.

The SPS deposition parameters of the yttria stabilized zirconia and gadolinia stabilized zirconia coatings of the instant invention may be varied to deposit coatings with different microstructures. As shown in Kassner et al., Journ. of Thermal Spray Technology, 17, 115 (2008) and Trice et al. Journ. of Thermal Spray Tech., 20, 817 (2011) and incorporated herein by reference in their entirety, SPS may deposit ceramic coatings with strain tolerant microstructures with microcracks perpendicular to a substrate by adjusting spray deposition conditions. In addition, as shown in Fauchais et al. Journ. of Thermal Spray Technology, 17, 31 (2008) and incorporated herein by reference in its entirety, SPS may generate dense coatings suitable for sealing by similarly adjusting spray deposition conditions.

Prior art teaching of multi-layer ceramic barrier coatings comprising a low density layer of a strain tolerant columnar microstructure capped by a higher density erosion and CMAS resistant layer produced by electron beam physical vapor deposition (EBPVD) is disclosed in U.S. Pat. No. 6,982,126 to Darolia et al. and U.S. 2009/0038935 to Floyd et al. In both cases, the physical set up and deposition conditions were altered in order to successfully deposit both layers. In contrast, in the present invention, deposition of thermal barrier coating 14 and protective sealing layer 16 by SPS can be performed by changing only the deposition parameters and not the physical deposition conditions. In the embodiment of the present invention, the economical and production benefits of SPS deposition are evident.

As noted above, both thermal barrier coat 14 and sealing layer 16 may be deposited by the same equipment without changing the deposition setup. Feedstock and all spray deposition conditions may be efficiently changed to deposit the same or different coatings with predetermined microstructures without demounting the SPS spray target.

It is to be understood that, while the specification is describing a single two layer (or three layer with a bond coat included) structure, other multilayer structures containing at least two of each coating described above in any of a number of sequences are possible. As an example, FIG. 2 shows turbine engine component 20 and thermal barrier coating 14A on at least one surface of substrate 12. Substrate 12 may be formed from any suitable material known in the art such as a nickel based superalloy, a cobalt based superalloy, a molybdenum based alloy, or a niobium based alloy. Alternatively, substrate 12 may be a ceramic based substrate or a ceramic matrix composite substrate. Thermal barrier coating 14A may comprise one or more layers of a ceramic material such as a yttria stabilized zirconia material or a gadolinia stabilized zirconia material. The yttria stabilized zirconia material may contain from about 1.0 to about 25 wt. % yttria and the balance zirconia. The gadolinia stabilized zirconia material may contain from about 5.0 to about 99.9 wt. % gadolinia, more preferably about 30 to about 70 wt. % gadolinia and the balance zirconia. Thermal barrier coating 14A may have a thickness from about 25 microns to about 1300 microns.

If desired, a bond coat may be deposited on the substrate prior to the application of thermal barrier coating 14A. The bond coat may be either a MCrAlY coating where M is nickel and/or cobalt, an aluminide coating, a platinum aluminide coating, a ceramic based bond coat, or a silica based bond coat. The bond coat may be applied using any suitable technique known in the art.

After thermal barrier coating 14A has been applied to substrate 12, sealing layer 16A is applied to thermal barrier coating 14A. Protective sealing layer 16A may be rare earth stabilized zirconia, rare earth stabilized hafnia, and mixtures thereof. In an embodiment, protective sealing layer 16A may be yttria stabilized zirconia, gadolinia stabilized zirconia, yttria stabilized hafnia, gadolinia stabilized hafnia, and mixtures thereof. Preferably, protective sealing layer 16A may be yttria stabilized zirconia containing from about 17 wt. % yttria to about 65 wt. % yttria, gadolinia stabilized zirconia containing from about 25 wt. % gadolinia to about 70 wt. % gadolinia, yttria stabilized hafnia containing from about 11 wt. % yttria to about 52 wt. % yttria, gadolinia stabilized hafnia containing from about 16 wt. % hafnia to about 53 wt. % hafnia, and mixtures thereof. Most preferably, protective sealing layer 16A is gadolinium zirconate, Gd₂Zr₂O₇. Protective sealing layer 16 is denser than thermal barrier layer 14 and has a porosity less than 20%, more preferably less than 10% and a minimum amount of vertical gaps or microcracks.

In the embodiment shown in FIG. 2, thermal barrier coating 14B is deposited on sealing layer 16A. The compositions of thermal barrier coating 14B are identical to those of thermal barrier coating 14A. Sealing layer 16B is then deposited on thermal barrier coat 14B. Again, the composition of sealing layer 16B is identical to that of 16A. In another embodiment, thermal barrier coating 14A may be yttria stabilized zirconia and a second low thermal conductivity thermal barrier coating may also be on thermal barrier coating 14A under sealing layer 16B. The second thermal barrier coating may be yttria stabilized zirconia, gadolinia stabilized zirconia, or mixtures thereof. Preferably, the second thermal barrier coating may be the compound, Gd₂Zr₂0₇ (GZO). As noted above, this or other sequences of layers in the hybrid thermal barrier coating of the invention may be formed according to the requirements of the specific application.

In another embodiment, by changing feedstock in a continuous manner, the microstructures and compositions of thermal barrier coatings 14, 14A and others and top protective layers 16, 16A and others may be continually changed during deposition to form coatings with gradient microstructures and compositions.

The benefit of the present invention is a suspension plasma sprayed thermal barrier coating system that provides thermal protection while resisting penetration of molten silicate material, thereby providing enhanced durability in environments where sand induced distress of turbine airfoils occurs.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

### Discussion of Possible Embodiments

The following are non-exclusive descriptions of possible embodiments of the present invention:

A turbine engine component can include a substrate; a thermal barrier layer deposited on the substrate by suspension plasma spray comprising a strain tolerant microstructure; and a molten silicate resistant sealing layer deposited on the thermal barrier layer by suspension plasma spray wherein the sealing layer has a porosity less than about 10% and acts as a barrier to prevent penetration of molten sand into the thermal barrier layer.

The turbine engine component of the preceding paragraph can optionally include, additionally and/or alternatively any, one or more, of the following features, configurations, and/or additional components:

a thermal barrier layer comprising yttria stabilized zirconia, gadolinia stabilized zirconia, or mixtures thereof and a sealing layer comprising yttria stabilized zirconia, gadolinia stabilized zirconia, yttria stabilized hafnia, gadolinia stabilized hafnia, gadolinium zirconate, and mixtures thereof;

the thermal barrier layer can have a thickness of from about 25 microns to about 300 microns;

the thermal barrier layer can comprise yttria stabilized zirconia and contain about 4 to about 25 wt. % yttria;

the sealing layer can have a thickness of from about 5 microns to about 150 microns;

the sealing layer can further comprise gadolinia stabilized zirconia and can contain from about 25 to about 99.9 wt. % gadolinia;

the sealing layer can further comprise gadolinium zirconate;

the thermal barrier layer and sealing layer can comprise gradient compositions;

the thermal barrier layer and sealing layer can be repeated at least one time;

the substrate of the turbine engine component can be formed from a nickel based alloy, a cobalt based alloy, a molybdenum based alloy or a niobium based alloy;

the thermal barrier layer can have a porosity of from about 10 to about 30%.

A method of forming a hybrid thermal barrier coating system can comprise: a suspension plasma sprayed thermal barrier layer comprising yttria stabilized zirconia, gadolinia stabilized zirconia, or mixtures thereof comprising strain tolerant microstructures on a turbine engine component; a suspension plasma sprayed molten silicate resistant sealing layer comprising yttria stabilized zirconia, gadolinia stabilized zirconia, yttria stabilized hafnia, gadolinia stabilized hafnia, gadolinium zirconate, or mixtures thereof on the thermal barrier layer wherein the sealing layer has a porosity of from about 2 to about 10% and acts as a barrier to prevent penetration of molten sand into the thermal barrier coating.

The method of the preceding paragraph can optionally include, additionally and/or alternatively any, one or more of the following features, configurations, and/or additional components:

a thermal barrier layer comprising a thickness of from about 125 microns to about 1300 microns;

a thermal barrier layer of yttria stabilized zirconia containing from about 4 to about 25 wt. % yttria;

a molten silicate resistant sealing layer comprising a thickness of from about 5 microns to about 150 microns;

a molten silicate resistant layer comprising gadolinia stabilized zirconia containing from about 25 to about 99.9 wt. % gadolinia;

a molten silicate resistant layer comprising gadolinium zirconate;

a thermal barrier coating and sealing layer wherein both comprise gradient compositions;

the thermal barrier layers and sealing layers can be repeated at least one time during formation;

the substrate can comprise a nickel based alloy, a cobalt based alloy, a molybdenum based alloy, or a niobium based alloy;

the thermal barrier layer can have a porosity of from about 10 to about 30%;

the thermal barrier layer and sealing layer can comprise gradient microstructures.

1. A turbine engine component comprising:
a substrate;
a thermal barrier layer deposited on the substrate by suspension plasma spray comprising a strain tolerant microstructure; and
a molten silicate resistant sealing layer deposited on the thermal barrier layer by suspension plasma spray, the sealing layer having a porosity less than about 10% to act as a barrier to prevent penetration of molten sand into the thermal barrier layer.

2. The turbine engine component of claim 1, wherein the thermal barrier layer comprises yttria stabilized zirconia, gadolinia stabilized zirconia, or mixtures thereof and the sealing layer comprises yttria stabilized zirconia, gadolinia stabilized zirconia, yttria stabilized hafnia, gadolinia stabilized hafnia, gadolinium zirconate, and mixtures thereof.

3. The turbine engine component of claim 1, wherein the thermal barrier layer has a thickness of from about 25 microns to about 1300 microns.

4. The turbine engine component of claim 3, wherein thermal barrier layer comprises yttria stabilized zirconia and contains from about 4 to about 25 wt. % yttria.

5. The turbine engine component of claim 1, wherein the sealing layer has a thickness of from about 5 microns to about 150 microns.

6. The turbine engine component of claim 5, wherein the sealing layer comprises gadolinia stabilized zirconia and contains from about 25 to about 99.9 wt. % gadolinia.

7. The turbine engine component of claim 5, wherein the sealing layer comprises gadolinium zirconate.

8. The turbine engine component of claim 1, wherein the thermal barrier layer and sealing layer comprise gradient compositions.

9. The turbine engine component of claim 1, wherein the thermal barrier layer and sealing layer are repeated at least one time.

10. The turbine engine component of claim 1, wherein the substrate is formed from a nickel based alloy, a cobalt based alloy, a molybdenum based alloy or a niobium based alloy.

11. The turbine engine component of claim 1, wherein the thermal barrier layer has a porosity of from about 10 to about 30%.

12. A method of forming a hybrid thermal barrier coating system, the method comprising:
suspension plasma spraying a thermal barrier layer comprising yttria stabilized zirconia, gadolinia stabilized zirconia, or mixtures thereof with a strain tolerant microstructure on a substrate; and
suspension plasma spraying a molten silicate resistant sealing layer comprising yttria stabilized zirconia, gadolinia stabilized zirconia, yttria stabilized hafnia, gadolinia stabilized hafnia, gadolinium zirconate, or mixtures thereof on the thermal barrier layer wherein the sealing layer has a porosity of from about 2 to about 10% to act as a barrier to prevent penetration of molten sand into the thermal barrier coating.

13. The method of claim 12, wherein the thermal barrier layer has a thickness of from about 125 microns to about 1300 microns.

14. The method of claim 13, wherein the thermal barrier layer of yttria stabilized zirconia contains from about 4 to about 25 wt. % yttria.

15. The method of claim 12, wherein the molten silicate resistant sealing layer has a thickness of from about 5 microns to about 150 microns.

16. The method of claim 15, wherein the molten silicate resistant layer of gadolinia stabilized zirconia contains from about 25 to about 99.9 wt. % gadolinia.

17. The method of claim 14, wherein the molten silicate resistant layer is gadolinium zirconate.

18. The method of claim 12, wherein the thermal barrier coating and sealing layer comprise gradient compositions.

19. The method of claim 12, wherein the thermal barrier layers and sealing layers of the hybrid thermal barrier coating system are repeated at least one time.

20. The method of claim 12, wherein the substrate is formed from a nickel based alloy, a cobalt based alloy, a molybdenum based alloy or a niobium based alloy.

21. The method of claim 12, wherein the thermal barrier layer has a porosity of from about 10 to about 30%.

22. The method of claim 12, wherein the thermal barrier layer and sealing layer comprise gradient microstructures.
